(19) United States
(12) Patent Application Publication
(10) Pub. No.: US 2018/0039629 A1
(43) Pub. Date: Feb. 8, 2018

(54) METHOD AND SYSTEM FOR AUTOMATIC RANKING OF ONLINE MULTIMEDIA ITEMS

(71) Applicant: YEN4KEN, INC., Princeton, NJ (US)

(72) Inventors: Harish Arsikere, Bangalore (IN); Sonal S. Patil, Dhule (IN); Om D. Deshmukh, Bangalore (IN)

(21) Appl. No.: 15/226,940

(22) Filed: Aug. 3, 2016

(51) Int. Cl. G06F 17/30; G06N 99/00

(52) U.S. Cl. CPC G06F 17/3005; G06F 17/3053; G06F 17/30598; G06N 99/005

(57) ABSTRACT

The disclosed embodiments illustrate methods and systems of multimedia content processing for automatic ranking of online multimedia items. The method includes selecting one or more multimedia items based on a user-request. For a multimedia item from the one or more selected multimedia items, the method includes determining a plurality of features from the multimedia item based on audio content, text content and visual content associated with the multimedia item. The method further includes classifying the plurality of features into a plurality of speaking style categories. The method further includes determining an engagement score for the multimedia item based on the classified plurality of features and a weight associated with each of the plurality of speaking style. The method further includes ranking the one or more multimedia items based on at least the determined engagement score associated with each of the one or more multimedia items.

### TECHNICAL FIELD

The presently disclosed embodiments are related, in general, to multimedia content processing. More particularly, the presently disclosed embodiments are related to methods and systems for automatic ranking of online multimedia items.

### BACKGROUND

Recent advancements in the fields of computer networks and information technology have led to the usage of multimedia content as a popular means of knowledge sharing and online learning. Generally, various organizations upload large amount of multimedia content, such as Massive Open Online Courses (MOOCs) and Small Private Online Courses (SPOCs), on various websites for the usage by multiple users. To view topic-specific multimedia content, such users transmit one or more search queries on various websites. In response to the transmitted one or more search queries, the users may receive one or more topic-specific multimedia items from various websites.

Typically, the received one or more topic-specific multimedia items may be indexed and/or ranked based on one or more parameters, such as relevance to topic, presence of search keywords in the one or more multimedia items, identity and affiliation of the uploader, and/or the like. However, indexing and/or ranking the one or more multimedia items based on a level of engagement offered by the one or more multimedia items is an arduous task. Therefore, an advanced and dynamic mechanism is required, to automatically rank the multimedia items based on the level of engagement offered in real time.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method of multimedia content processing for automatic ranking of online multimedia items. The method includes selecting, by one or more processors in a computing device, one or more multimedia items based on a user-request received from a user-computing device. For a multimedia item from the one or more selected multimedia items, the method includes determining, by the one or more processors in the computing device, a plurality of features from the multimedia item based on audio content, text content and visual content associated with the multimedia item. The method further includes classifying, by the one or more processors in the computing device, the plurality of features into a plurality of speaking style categories based on an association of the plurality of features with the plurality of speaking style categories. The method further includes determining, by the one or more processors in the computing device, an engagement score for the multimedia item based on the classified plurality of features and a weight associated with each of the plurality of speaking style categories by utilizing a first classifier. Further, the first classifier is trained based on the plurality of features determined from one or more other multimedia items. The method further includes ranking, by the one or more processors in the computing device, the one or more multimedia items based on at least the determined engagement score associated with each of the one or more multimedia items, wherein the ranked one or more multimedia items are presented to a user through a user-interface displayed on the user-computing device.

According to embodiments illustrated herein, there is provided a system for multimedia content processing for automatic ranking of online multimedia items. The system includes one or more processors configured to select one or more multimedia items based on a user-request received from a user-computing device. For a multimedia item from the one or more selected multimedia items, the one or more processors are configured to determine a plurality of features from the multimedia item based on audio content, text content and visual content associated with the multimedia item. The one or more processors are further configured to classify the plurality of features into a plurality of speaking style categories based on an association of the plurality of features with the plurality of speaking style categories. The one or more processors are further configured to determine an engagement score for the multimedia item based on the classified plurality of features and a weight associated with each of the plurality of speaking style categories by utilizing a first classifier. Further, the first classifier is trained based on the plurality of features determined from one or more other multimedia items. The one or more processors are further configured to rank the one or more multimedia items based on at least the determined engagement score associated with each of the one or more multimedia items, wherein the ranked one or more multimedia items are presented to a user through a user-interface displayed on the user-computing device.

According to embodiments illustrated herein, there is provided a computer program product for use with a computing device. The computer program product comprises a non-transitory computer readable medium storing a computer program code for automatic ranking of online multimedia items. The computer program code is executable by one or more processors to select one or more multimedia items based on a user-request received from a user-computing device. For a multimedia item from the one or more selected multimedia items, the computer program code is executable by the one or more processors to determine a plurality of features from the multimedia item based on audio content, text content and visual content associated with the multimedia item. The computer program code is further executable by the one or more processors to classify the plurality of features into a plurality of speaking style categories based on an association of the plurality of features with the plurality of speaking style categories. The computer program code is further executable by the one or more processors to determine an engagement score for the multimedia item based on the classified plurality of features and a weight associated with each of the plurality of speaking style categories by utilizing a first classifier, wherein the first classifier is trained based on the plurality of features determined from one or more other multimedia items. The computer program code is further executable by the one or more processors to rank the one or more multimedia items based on at least the determined engagement score associated with each of the one or more multimedia items, wherein the ranked one or more multimedia items are presented to a user through a user-interface displayed on the user-computing device.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a system environment, in which various embodiments can be implemented, in accordance with at least one embodiment;

FIG. 2 is a block diagram that illustrates an application server, in accordance with at least one embodiment;

FIG. 3 is a flowchart that illustrates a method of training classifiers for automatic ranking of online multimedia items, in accordance with at least one embodiment;

FIGS. 4A and 4B, collectively, depict a flowchart that illustrates a method of multimedia content processing for automatic ranking of online multimedia items, in accordance with at least one embodiment;

FIG. 5 is a block diagram of an exemplary scenario for training classifiers for automatic ranking of online multimedia items, in accordance with at least one embodiment; and

FIG. 6 is a block diagram of an exemplary scenario for automatic ranking of online multimedia items by use of trained classifiers, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### Definitions

The following terms shall have, for the purposes of this application, the meanings set forth below.

A “user-computing device” refers to a computer, a device (that includes one or more processors/microcontrollers and/or any other electronic components), or a system (that performs one or more operations according to one or more programming instructions/codes) associated with a user. In an embodiment, the user-computing device may be utilized by the user to transmit a user-request to receive topic-specific multimedia items. Examples of the user-computing device may include, but are not limited to, a desktop computer, a laptop, a personal digital assistant (PDA), a mobile device, a smartphone, and a tablet computer (e.g., iPad® and Samsung Galaxy The).

A “multimedia item” refers to content that uses a combination of different content forms, such as audio, video, text, image, animation, and/or interactive content. In an embodiment, the multimedia item may be played through a media player, such as VLC Media Player®, Windows Media Player®, Adobe Flash Player®, and Apple QuickTime Player®, on a computing device. In an embodiment, the multimedia item may be downloaded or streamed from a multimedia server to the computing device. In an alternate embodiment, the multimedia item may be stored on a media storage device such as hard disk drive (HDD), CD Drive, pen drive, etc., connected to (or built within) the computing device.

A “plurality of features” refers to a plurality of characteristics associated with a multimedia item. The plurality of features may include a set of acoustic features, a set of lexical features, and a set of visual features. The plurality of features is determined from the multimedia item by utilizing one or more of: speech processing techniques, text processing techniques, and video processing techniques. In an embodiment, the plurality of features may be indicative of an engagement level associated with the multimedia item.

A “set of acoustic features” refers to a set of features that is determined based on audio content of a multimedia item. The set of acoustic features may be determined from the multimedia item by utilizing one or more speech processing techniques, such as pitch tracking, harmonic frequency tracking, speech activity detection, a spectrogram computation, and/or the like. In an embodiment, an acoustic feature in the set of acoustic features may correspond to pitch, intensity, duration of phonemes and/or syllables, speech rate, rhythm and/or the like.

A “set of lexical features” refers to a set of features that is determined based on text content of a multimedia item. The set of lexical features may be determined from the multimedia item by utilizing one or more text processing techniques, such as n-gram modelling, parts of speech tagging, syntax extraction, and/or the like. In an embodiment, a lexical feature in the set of lexical features may correspond to a filler keyword, a grammatical structure, and/or the like.

A “set of visual features” refers to a set of features that is determined based on video content of a multimedia item. The set of visual features may be determined from the multimedia item by utilizing one or more video processing techniques, such as gesture recognition, articulator movement tracking, and/or the like. In an embodiment, a visual feature in the set of visual features may correspond to a gesture and a movement of vocal-track articulators of a subject, such as an individual, in the multimedia item.

A “plurality of speaking style categories” refers to a plurality of speaking style attributes associated with a multimedia item. Examples of the plurality of speaking style categories may include, but are not limited to, “liveliness,” “clarity,” “fluency,” and “formality.” In an embodiment, the plurality of speaking style categories may be associated with an engagement level offered by the multimedia item. For example, a clear and lively multimedia item may be more engaging than another multimedia item that is unclear and less lively.

An “engagement score” refers to a score that is indicative of an engagement level offered by a multimedia item. For example, a high engagement score may indicate that the multimedia item is highly engaging, whereas a low engagement score may indicate the engagement offered by the multimedia item is very less. In an embodiment, the engagement score may be determined based on a plurality of features classified into a plurality of speaking style categories. In an embodiment, a first classifier may be trained to determine the engagement score of a multimedia item.

A “weight” refers to a strength of dependency between engagement level of a multimedia item and a speaking style category. In an embodiment, a weight of each of the plurality of speaking style categories may be determined based on a correlation between each of the plurality of speaking style categories and the engagement attribute of the multimedia item. For example, a high correlation value may indicate a higher dependency between a speaking style category and engagement level of a multimedia item. In such a case, the weight of the speaking style category may also be high.

“Ranking” refers to a technique of sorting one or more multimedia items based on a specific parameter. In an embodiment, the one or more multimedia items may be ranked based on an engagement score. In another embodiment, the one or more multimedia items may be ranked based on each of a plurality of speaking style scores associated with a plurality of speaking style categories. In an embodiment, the one or more multimedia items may be ranked in an ascending order or descending order based on the corresponding parameter.

A “score” refers to a rating provided by a user to a multimedia item for a plurality of speaking style categories and an engagement attribute. In an embodiment, the user may first view the multimedia item and then assign the score. In an embodiment, the user may assign the score that may lie in a pre-specified range, such as “0-100.” For example, after viewing a first multimedia item, the user may assign a score, such as “89,” for a speaking style category, such as “clarity.” The user may further assign a score, such as “45,” for the speaking style category, such as “clarity” to a second multimedia item. Thus, based on the scores provided by the user, an inference may be drawn that the user finds the first multimedia item to be clearer than the second multimedia item.

An “engagement attribute” refers to an attribute that is indicative of an engagement level offered by a multimedia item. In an embodiment, one or more users may assign scores to one or more multimedia items based on the engagement attribute. A multimedia item that has the highest score may be considered the most engaging video among the one or more multimedia items.

A “speaking style score” refers to a score that is indicative of an association of a multimedia item with a speaking style category. For example, a high speaking style score for a speaking style category, such as “fluency,” may indicate that the multimedia item is highly fluent, whereas a low speaking style score may indicate that the multimedia item is less fluent. In an embodiment, the speaking style score for a speaking style category for the multimedia item may be determined based on a plurality of features classified under the corresponding speaking style category. In an embodiment, a second classifier of a plurality of second classifiers may be trained to determine the speaking style score for the corresponding speaking style category for the multimedia item.

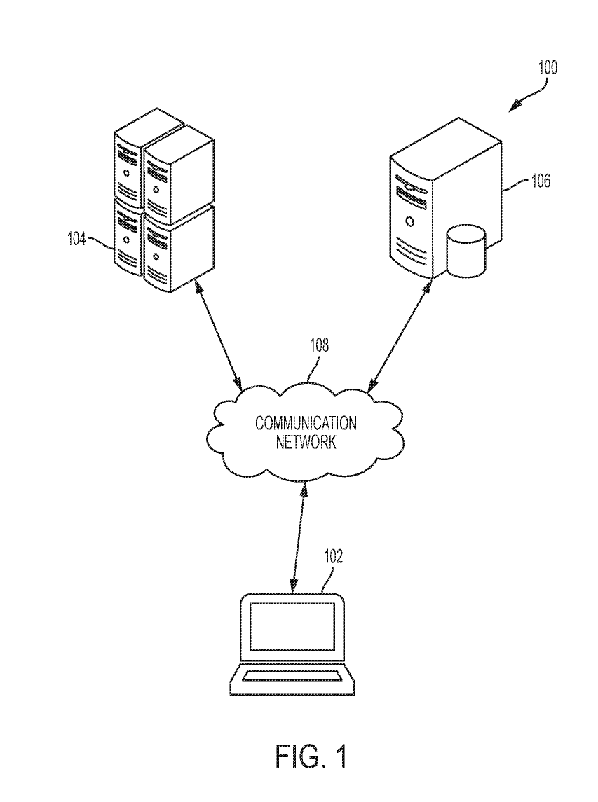

FIG. 1 is a block diagram of a system environment in which various embodiments may be implemented. With reference to FIG. 1, there is shown a system environment 100 that includes one or more user-computing devices, such as a user-computing device 102, one or more application servers, such as an application server 104, one or more database servers, such as a database server 106, and a communication network 108. Various devices in the system environment 100 may be interconnected over the communication network 108. FIG. 1 shows, for simplicity, one user-computing device, such as the user-computing device 102, one application server, such as the application server 104, and one database server, such as the database server 106. However, it will be apparent to a person having ordinary skill in the art that the disclosed embodiments may also be implemented using multiple user-computing devices, multiple application servers, and multiple database servers, without departing from the scope of the disclosure.

The user-computing device 102 may refer to a computing device (associated with a user) that may be communicatively coupled to the communication network 108. The user-computing device 102 may include one or more processors and one or more memory units. The one or more memory units may include a computer readable code that may be executable by the one or more processors to perform one or more operations specified by the user. In an embodiment, the user may utilize the user-computing device 102 to transmit a user-request to the application server 104 for viewing one or more multimedia items associated with a specific topic. In an embodiment, the user-request may include a search query that corresponds to the specific topic of user's interest. In another embodiment, the user-request may further include one or more user preferences pertaining to a plurality of speaking style categories and a plurality of features associated with the one or more multimedia items. Examples of the plurality of speaking style categories may include, but are not limited to, “liveliness,” “fluency,” “clarity,” or “formality.” In an embodiment, the user-computing device 102 may be further utilized by the user to view the ranked one or more multimedia items through a user-interface received from the application server 104. In an embodiment, the user may further select at least one multimedia item from the ranked one or more multimedia items. Thereafter, the selected multimedia item may be rendered on a display screen of the user-computing device 102.

The user-computing device 102 may correspond to a variety of computing devices, such as, but not limited to, a laptop, a PDA, a tablet computer, a smartphone, and a phablet.

A person having ordinary skill in the art will understand that the scope of the disclosure is not limited to the utilization of the user-computing device 102 by a single user. In an embodiment, the user-computing device 102 may be utilized by more than one user to transmit the user-request.

The application server 104 may refer to a computing device or a software framework hosting an application or a software service that may be communicatively coupled to the communication network 108. In an embodiment, the application server 104 may be implemented to execute procedures, such as, but not limited to, programs, routines, or scripts stored in one or more memory units for supporting the hosted application or the software service. In an embodiment, the hosted application or the software service may be configured to perform one or more predetermined operations of multimedia content processing.

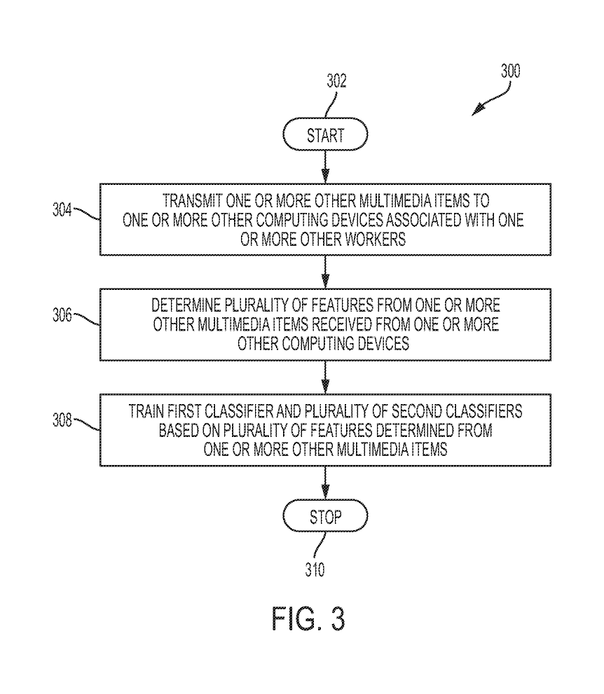

In an embodiment, the application server 104 may be configured to transmit one or more other multimedia items to one or more other computing devices (not shown) associated with one or more other users. The one or more other users are presented a task by the application server 104 to assign a score, to each of the one or more other multimedia items, for each of the plurality of speaking style categories and an engagement attribute associated with each of the one or more other multimedia items. Thereafter, the application server 104 may determine a plurality of features from the one or more other multimedia items received from the one or more other computing devices. In an embodiment, the application server 104 may determine the plurality of features based on audio content, text content, and visual content in each of the one or more other multimedia items. In an embodiment, the plurality of features may comprise a set of acoustic features associated with the audio content, a set of lexical features associated with the text content, and a set of visual features associated with the visual content. The application server 104 may utilize one or more multimedia processing techniques known in the art for the determination of the plurality of features. In an embodiment, the one or more multimedia processing techniques may comprise one or more of: speech processing techniques, text processing techniques, and video processing techniques. In an embodiment, the application server 104 may utilize the plurality of features determined from the one or more other multimedia items for training a first classifier and a plurality of second classifiers. In an embodiment, a second classifier among the plurality of second classifiers is associated with a speaking style category among the plurality of speaking style categories. Examples of the first classifier and the plurality of second classifiers may include, but are not limited to, a Support Vector Machine (SVM), a Logistic Regression, a Bayesian classifier, a Decision Tree classifier, a Copula-based classifier, a K-Nearest Neighbors (KNN) classifier, or a Random Field (RF) classifier. The training of the classifiers (i.e., the first classifier and the plurality of second classifiers) for automatic ranking of the multimedia items has been explained later in FIG. 3.

Thereafter, the application server 104 may determine an association of the plurality of features with the plurality of speaking style categories based on the score assigned by the one or more other users to each of the one or more other multimedia items for each of the plurality of speaking style categories. In an embodiment, the application server 104 may classify the plurality of features into the plurality of speaking style categories based on the association. The application server 104 may be further configured to determine a weight associated with each of the plurality of speaking style categories, based on the score assigned by the one or more other users. In an embodiment, the application server 104 may be configured to store the weight associated with each of the plurality of speaking style categories in the database server 106.

In an embodiment, the application server 104 may be configured to receive the user-request from the user-computing device 102. The application server 104 may further query the database server 106 for selecting the one or more multimedia items from a plurality of multimedia items stored in the database server 106 based on the user-request. After, the selection of the one or more multimedia items, the application server 104 may be configured to determine the plurality of features from each of the selected one or more multimedia items. In an embodiment, the application server 104 may be configured to classify the plurality of features of each of the one or more multimedia items into the plurality of speaking style categories. The application server 104 may classify the plurality of features based on the determined association of the plurality of features with the plurality of speaking style categories.

Further, the application server 104 may be configured to determine an engagement score for each of the one or more multimedia items based on the corresponding classified plurality of features by utilizing the first classifier. The application server 104 may further utilize the weight associated with each of the plurality of speaking style categories for the determination of the engagement score. In an embodiment, when the user-request includes the one or more user preferences, the application server 104 may be further configured to determine a speaking style score, for each of the one or more multimedia items, for each of the plurality of speaking style categories. The application server 104 may determine the speaking style score based on the classified plurality of features by utilizing the plurality of second classifiers.

In an embodiment, the application server 104 may utilize the determined engagement scores of the one or more multimedia items for ranking the one or more multimedia items. Based on the one or more user preferences in the user-request, the application server 104 may further rank the one or more multimedia items for each of the corresponding plurality of speaking style categories by use of the speaking style scores of the one or more multimedia items. Thereafter, the application server 104 may be configured to present the ranked one or more multimedia items through the user-interface displayed on the display screen of the user-computing device 102.

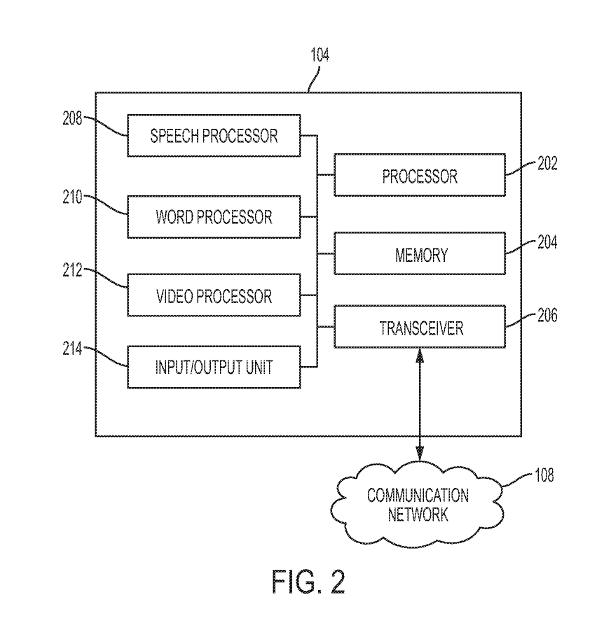

The application server 104 may be realized through various types of application servers, such as, but not limited to, a Java application server, a .NET framework application server, a Base4 application server, a PHP framework application server, or any other application server framework. An embodiment of the structure of the application server 104 has been discussed later in FIG. 2.

A person having ordinary skill in the art will appreciate that the scope of the disclosure is not limited to realizing the application server 104 and the user-computing device 102, as separate entities. In an embodiment, the application server 104 may be realized as an application program installed on and/or running on the user-computing device 102, without deviating from the scope of the disclosure.

The database server 106 may refer to a computing device that may be communicatively coupled to the communication network 108. In an embodiment, the database server 106 may be configured to perform one or more database operations. The one or more database operations may include one or more of, but not limited to, receiving, storing, processing, and transmitting one or more queries, data, or content. The one or more queries, data, or content may be received/transmitted from/to various components of the system environment 100. In an embodiment, the database server 106 may be configured to store the plurality of multimedia items. In an embodiment, the database server 106 may be further configured to store the weight associated with each of the plurality of speaking style categories. In an embodiment, the database server 106 may be configured to receive one or more queries from the application server 104 for the selection of the one or more multimedia items from the plurality of multimedia items and the retrieval of the weight associated with each of the plurality of speaking style categories.

For querying the database server 106, one or more querying languages, such as, but not limited to, SQL, QUEL, and DMX, may be utilized. In an embodiment, the database server 106 may connect to the application server 104, using one or more protocols, such as, but not limited to, the ODBC protocol and the JDBC protocol. In an embodiment, the database server 106 may be realized through various technologies such as, but not limited to, Microsoft® SQL Server, Oracle®, IBM DB2®, Microsoft Access®, PostgreSQL®, MySQL® and SQLite®.

A person having ordinary skill in the art will appreciate that the scope of the disclosure is not limited to realizing the database server 106 and the application server 104 as separate entities. In an embodiment, the functionalities of the database server 106 can be integrated into the application server 104, without departing from the scope of the disclosure.

The communication network 108 may correspond to a medium through which content and messages flow between various devices, such as the user-computing device 102, the application server 104, and the database server 106, of the system environment 100. Examples of the communication network 108 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the communication network 108 in accordance with various wired and wireless communication protocols such as Transmission Control Protocol and Internet Protocol (TCP/IP), User Datagram Protocol (UDP), and 2G, 3G, or 4G communication protocols.

FIG. 2 is a block diagram that illustrates an application server, in accordance with at least one embodiment. FIG. 2 has been described in conjunction with FIG. 1. With reference to FIG. 2, there is shown a block diagram of the application server 104 that may include a processor 202, a memory 204, a transceiver 206, a speech processor 208, a word processor 210, a video processor 212, and an input/output unit 214. The processor 202 is communicatively coupled to the memory 204, the transceiver 206, the speech processor 208, the word processor 210, the video processor 212, and the input/output unit 214.

The processor 202 includes suitable logic, circuitry, and/or interfaces that are configured to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform one or more operations for multimedia content processing. In an embodiment, the processor 202 may be configured to select the one or more multimedia items based on the user-request received from the user-computing device 102. In an embodiment, the processor 202 may be further configured to classify the plurality of features into the plurality of speaking style categories. Further, the processor 202 may utilize the classified plurality of features to determine the engagement score and the speaking style score, for each of the plurality of speaking style categories, for each of the one or more multimedia items. In an embodiment, the processor 202 may be further configured to rank the one or more multimedia items based on one or both of the corresponding engagement score and the corresponding speaking style score for each of the plurality of speaking style categories. In an embodiment, the processor 202 may be further configured to present the task to the one or more other users for assigning the score to the one or more other multimedia items. The processor 202 may be implemented based on a number of processor technologies known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store the one or more sets of instructions that are executable by the processor 202, the transceiver 206, the speech processor 208, the word processor 210, the video processor 212, and the input/output unit 214. In an embodiment, the memory 204 may include one or more buffers (not shown). The one or more buffers may store the selected one or more multimedia contents received from the database server 106. In an embodiment, the memory 204 may be further configured to store the determined plurality of features from each of the one or more multimedia items, the engagement scores, the speaking style scores of the one or more multimedia items. Examples of some of the commonly known memory implementations may include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations for multimedia content processing. It will be apparent to a person having ordinary skill in the art that the one or more instructions stored in the memory 204 may enable the hardware of the application server 104 to perform the one or more predetermined operations, without deviating from the scope of the disclosure.

The transceiver 206 transmits/receives messages and data to/from various components, such as the user-computing device 102 and the database server 106 of the system environment 100, over the communication network 108. In an embodiment, the transceiver 206 may be communicatively coupled to the communication network 108. In an embodiment, the transceiver 206 may be configured to receive the selected one or more multimedia items from the database server 106, over the communication network 108. In an embodiment, the transceiver 206 may be further configured to transmit the one or more other multimedia items to the one or more other computing devices (not shown). Further, the transceiver 206 may be configured to transmit the ranked one or more multimedia items to the user-computing device 102. Examples of the transceiver 206 may include, but are not limited to, an antenna, an Ethernet port, a USB port, or any other port configured to receive and transmit data. The transceiver 206 transmits/receives the messages and data, in accordance with the various communication protocols, such as TCP/IP, UDP, and 2G, 3G, or 4G communication protocols.

The speech processor 208 comprises suitable logic, circuitry, and/or interfaces that are configured to execute one or more instructions stored in the memory 204. In an embodiment, the speech processor 208 may be configured to work in conjunction with the processor 202 to determine the set of acoustic features, in the plurality of features, associated with the audio content of each of the one or more multimedia items. The speech processor 208 may utilize one or more speech processing techniques known in the art for determining the set of acoustic features. Examples of the one or more speech processing techniques may include, but are not limited to, pitch tracking, harmonic frequency tracking, speech activity detection, and a spectrogram computation. In an embodiment, an acoustic feature in the set of acoustic features may correspond to pitch, intensity, duration of phonemes and/or syllables, speech rate, rhythm and/or the like. In an embodiment, the speech processor 208 may be configured to perform automatic speech recognition (ASR) on the audio content of each of the one or more multimedia items to generate the corresponding text content. The speech processor 208 may be implemented using one or more processor technologies known in the art. Examples of the speech processor 208 may include, but are not limited to, an X86 processor, a RISC processor, a CISC processor, or any other processor. In another embodiment, the speech processor 208 may be implemented as an ASIC microchip designed for a special application, such as determining the set of acoustic features associated with each of the one or more multimedia items.

The word processor 210 comprises suitable logic, circuitry, and/or interfaces that are configured to execute one or more instructions stored in the memory 204. In an embodiment, the word processor 210 may be configured to work in conjunction with the processor 202 to determine the set of lexical features, in the plurality of features, associated with the text content of each of the one or more multimedia items. The word processor 210 may utilize one or more text processing techniques known in the art for determining the set of lexical features. Examples of the one or more text processing techniques may include, but are not limited to, n-gram modelling, parts of speech tagging, and syntax extraction. In an embodiment, a lexical feature in the set of lexical features may correspond to filler keywords, grammatical structure, and/or the like. The word processor 210 may be implemented using one or more processor technologies known in the art. Examples of the word processor 210 may include, but are not limited to, an X86 processor, a RISC processor, a CISC processor, or any other processor. In another embodiment, the word processor 210 may be implemented as an ASIC microchip designed for a special application, such as determining the set of lexical features associated with each of the one or more multimedia items.

The video processor 212 comprises suitable logic, circuitry, and/or interfaces that are configured to execute one or more instructions stored in the memory 204. In an embodiment, the video processor 212 may be configured to work in conjunction with the processor 202 to determine the set of visual features, in the plurality of features, associated with the video content of each of the one or more multimedia items. The video processor 212 may utilize one or more video processing techniques known in the art for determining the set of visual features. Examples of the one or more video processing techniques may include, but are not limited to, gesture recognition and articulator movement tracking. In an embodiment, a visual feature in the set of visual features may correspond to a gesture, a movement of vocal-track articulators and/or the like of a subject, such as an individual, in each of the one or more multimedia items. The video processor 212 may be implemented using one or more processor technologies known in the art. Examples of the video processor 212 may include, but are not limited to, an X86 processor, a RISC processor, a CISC processor, or any other processor. In another embodiment, the video processor 212 may be implemented as an ASIC microchip designed for a special application, such as determining the set of visual features associated with each of the one or more multimedia items.

A person having ordinary skill in the art will appreciate that the scope of the disclosure is not limited to realizing the speech processor 208, the word processor 210, the video processor 212, and the processor 202 as separate entities. In an embodiment, the functionalities of the speech processor 208, the word processor 210, and the video processor 212 may be implemented within the processor 202, without departing from the spirit of the disclosure. Further, a person skilled in the art will understand that the scope of the disclosure is not limited to realizing the speech processor 208, the word processor 210, and the video processor 212 as hardware components. In an embodiment, the speech processor 208, the word processor 210, and the video processor 212 may be implemented as software modules included in computer program code (stored in the memory 204), which may be executable by the processor 202 to perform the functionalities of each of the speech processor 208, the word processor 210, and the video processor 212.

The input/output unit 214 may comprise suitable logic, circuitry, interfaces, and/or code that may be configured to provide an output to the user and/or the service provider. The input/output unit 214 comprises various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

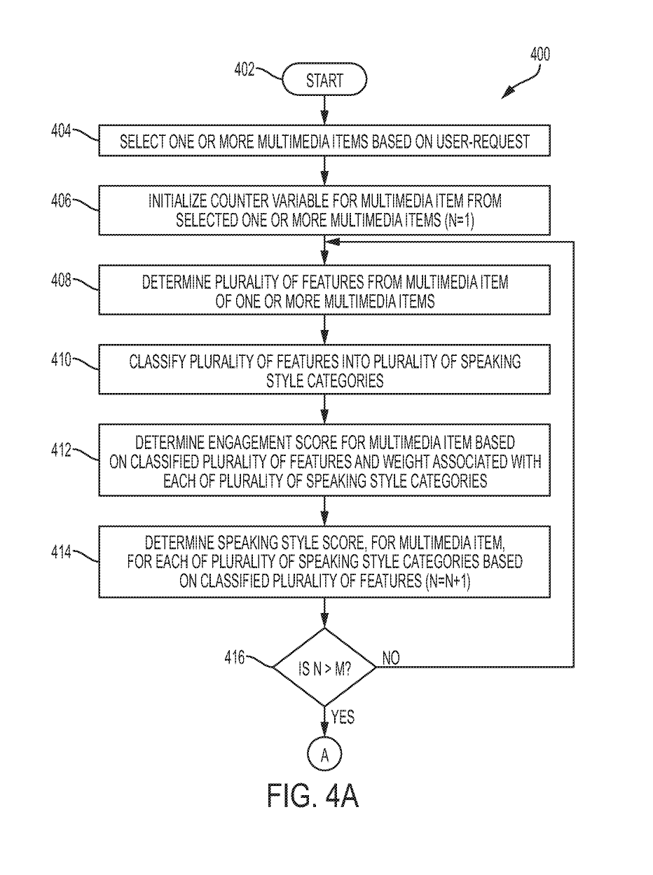

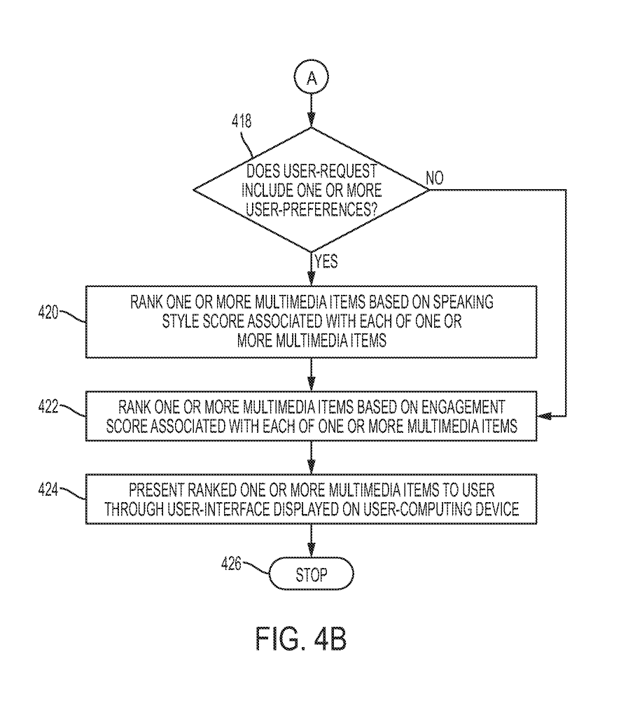

The working of the application server 104 for automatic ranking of online multimedia items has been explained later in FIGS. 4A and 4B.

FIG. 3 is a flowchart that illustrates a method of training classifiers for automatic ranking of online multimedia items, in accordance with at least one embodiment. FIG. 3 is described in conjunction with FIG. 1 and FIG. 2. With reference to FIG. 3, there is shown a flowchart 300 that illustrates a method of training classifiers for automatic ranking of online multimedia items. A person having ordinary skill in the art will understand that the examples, as described in FIG. 3 are for illustrative purpose and should not be construed to limit the scope of the disclosure. The method starts at step 302 and proceeds to step 304.

At step 304, the one or more other multimedia items are transmitted to the one or more other computing devices associated with the one or more other users. In an embodiment, the processor 202, in conjunction with the transceiver 206, may be configured to transmit the one or more other multimedia items to the one or more other computing devices (not shown) associated with the one or more other users. Along with the transmission of the one or more other multimedia items, the one or more other users are presented the task by the processor 202. In an embodiment, the task may include the assignment of the score, to each of the one or more other multimedia items, for each of the plurality of speaking style categories and the engagement attribute associated with each of the one or more other multimedia items.

In an exemplary scenario, the processor 202 may assign the task to three other users for assigning the score, between a range of “0-100,” to three other multimedia items for four speaking style categories (i.e., “liveliness,” “clarity,” “fluency,” and “formality”) and the engagement attribute. Table 1, as shown below, illustrates the scores assigned by the three other users.

TABLE 1
Scores assigned to three other multimedia items by three other users for each
of the four speaking style categories and the engagement attribute

| | | | | | | | | | | | | | Engagement | | |
|---|---|---|---|---|---|---|---|---|---|---|---|---|---|---|---|
| | Plurality of speaking style categories | | | | | | | | | | | | attribute | | |
| Other | liveliness | | | clarity | | | fluency | | | formality | | | engagement | | |
| users | M_1 | M_2 | M_3 | M_1 | M_2 | M_3 | M_1 | M_2 | M_3 | M_1 | M_2 | M_3 | M_1 | M_2 | M_3 |
| User_1 | 40 | 79 | 87 | 79 | 78 | 92 | 33 | 75 | 89 | 79 | 34 | 12 | 26 | 76 | 91 |
| User_2 | 32 | 71 | 91 | 83 | 77 | 89 | 28 | 70 | 91 | 67 | 37 | 21 | 31 | 71 | 89 |
| User_3 | 28 | 75 | 95 | 88 | 73 | 91 | 25 | 68 | 97 | 81 | 38 | 17 | 21 | 74 | 96 |

A person having ordinary skill in the art will understand that the abovementioned exemplary scenario is for illustrative purpose and should not be construed to limit the scope of the disclosure.

Thereafter, the processor 202, in conjunction with the transceiver 206, may receive the scored one or more other multimedia items from the one or more other computing devices (not shown). In an embodiment, the processor 202 may be configured to normalize the scores assigned by the one or more other users. For example, the processor 202 may determine an average, such as “50,” of the scores, such as “40,” “32,” and “28,” provided by the one or more other users to a multimedia items “M_1” among the one or more other multimedia items for a speaking style category “liveliness.” The average score “50” may correspond to the normalized score for the speaking style category “liveliness.”

At step 306, the plurality of features is determined from the one or more other multimedia items received from the one or more other computing devices. The processor 202, in conjunction with the speech processor 208, the word processor 210, and the video processor 212, may be configured to determine the plurality of features from the one or more other multimedia items received from the one or more other computing devices. In an embodiment, the one or more other features may include the set of acoustic features, the set of lexical features, and the set of visual features. The determination of the plurality of features has been explained later in FIGS. 4A and 4B.

Thereafter, the processor 202 may be configured to determine the association of each of the plurality of features with the plurality of speaking style categories based on the normalized scores associated with the one or more other multimedia items.

In an exemplary implementation, with reference to Table 1, the processor 202 may determine that the normalized scores of the three other multimedia items “M_1,” “M_2,” and “M_3” lie in almost a same range (i.e., >“70”) for the speaking style category “clarity.” Further, the processor 202 may determine that an acoustic feature, such as “speaking rate,” is similar for the three other multimedia items “M_1,” “M_2,” and “M_3.” Thus, the processor 202 may associate the acoustic feature, such as “speaking rate,” with the speaking style category “clarity.” Further, the processor 202 may determine that the normalized scores of the two other multimedia items “M_2” and “M_3” lie in same range for the speaking style category “formality” but the normalized score “M_1” is in a different range. Further, the processor 202 may determine that a lexical feature, such as “grammatical structure,” is similar for the two other multimedia items “M_2” and “M_3” but different for “M_1.” Thus, the processor 202 may associate the lexical feature, such as “grammatical structure,” with the speaking style category “formality.” Further, based on such determinations of the normalized scores and the plurality of features, the processor 202 may associate the set of acoustic features with the speaking style categories, such as “fluency,” “clarity,” and “liveliness,” the filler words in the set of lexical features with the speaking style category “fluency,” the gestures in the set of visual features with the speaking style category “liveliness,” and the movements of vocal-track articulators with the speaking style category “clarity.”

A person having ordinary skill in the art will understand that the abovementioned exemplary scenario is for illustrative purpose and should not be construed to limit the scope of the disclosure.

Thereafter, the processor 202 may classify the plurality of features into the plurality of speaking style categories based on the determined association. For example, the set of acoustic features determined from each of the one or more other multimedia items is classified under one of the speaking style categories “fluency,” “clarity,” and “liveliness.”

In an embodiment, the processor 202 may be further configured to determine the weight associated with each of the plurality of speaking style categories based on the score assigned by the one or more other users to each of the one or more other multimedia items for each of the plurality of speaking style categories and the engagement attribute. The weight of a speaking style category may indicate a strength of dependency between the speaking style category and the engagement attribute. For determining the weight of a speaking style category among the plurality of speaking style categories, the processor 202 may determine a correlation between the normalized score of the speaking style category and the normalized score of the engagement attribute of the one or more other multimedia items. For example, the processor 202 may determine correlation values, such as “0.89,” “0.85,” “0.67,” and “0.53,” for the correlation of each of the plurality of speaking style categories, such as “liveliness,” “clarity,” “fluency,” and “formality,” respectively, with the engagement attribute. Further, the processor 202 may be configured to normalize the correlation values, such as “0.89,” “0.85,” “0.67,” and “0.53,” for determining the weight associated with each of the plurality of speaking style categories.

At step 308, the first classifier and the plurality of second classifiers are trained based on the plurality of features determined from the one or more other multimedia items. In an embodiment, the processor 202 may be configured to train the first classifier and the plurality of second classifiers based on the plurality of features determined from the one or more other multimedia items.

In an embodiment, the processor 202 may utilize the classified plurality of features and the determined weight to train the first classifier. The processor 202 may further utilize the classified plurality of features associated with a speaking style category to train a second classifier for the corresponding speaking style category. Thus, the processor 202 may train the plurality of second classifiers for the plurality of speaking style categories. Control passes to end step 310.

FIGS. 4A and 4B, collectively, depict a flowchart that illustrates a method of multimedia content processing for automatic ranking of online multimedia items, in accordance with at least one embodiment. FIGS. 4A and 4B are collectively described in conjunction with FIG. 1 to FIG. 3. With reference to FIGS. 4A and 4B, there is shown a flowchart 400 that illustrates a method of multimedia content processing for automatic ranking of online multimedia items. A person having ordinary skill in the art will understand that the examples, as described in FIGS. 4A and 4B, are for illustrative purpose and should not be construed to limit the scope of the disclosure. The method starts at step 402 and proceeds to step 404.

At step 404, the one or more multimedia items are selected based on the user-request. In an embodiment, the processor 202 may be configured to select the one or more multimedia items based on the user-request. In an embodiment, the processor 202, in conjunction with the transceiver 206, may be configured to receive the user-request from the user-computing device 102, over the communication network 108. The user-request may include the search query associated with the specific topic of user's interest. For example, a user who wants to view one or more multimedia items associated with a specific topic, such as “theory of relativity,” may transmit a user-request with a search query, such as “lecture videos on Einstein's theory of relativity.” In another embodiment, the user-request may further include the one or more user preferences pertaining to the plurality of speaking style categories. For example, a user who wants to view one or more multimedia items associated with a specific topic, such as “theory of relativity,” may transmit a user-request with one or more preferences, such as “clear and fluent,” and a search query, such as “lecture videos on Einstein's theory of relativity.” In another embodiment, the user-request may further include the one or more user preferences pertaining to the plurality of features. For example, a user may only be concerned about the audio content and the text content of the multimedia item. Thus, the user may transmit a user-request with one or more preferences, such as “acoustic features and lexical features.”

In an embodiment, the processor 202, in conjunction with the transceiver 206, may query the database server 106 for selecting the one or more multimedia items when the user-request is received from the user-computing device 102. In an embodiment, the selection of the one or more multimedia items is based on the search query in the user-request. For example, among “100” multimedia items stored in the database server 106, “10” multimedia items are associated with a topic “gravitational force,” “25” multimedia items are associated with another topic “simple harmonic motion,” “35” multimedia items are associated with another topic “theory of relativity,” and “30” multimedia items are associated with another topic “theory of evolution.” The processor 202 may select the “35” multimedia items, associated with the topic “theory of relativity” based on the search query “lecture videos on Einstein's theory of relativity” in the user-request.

A person having ordinary skill in the art will understand that the scope of the selection of the one or more multimedia items is not limited from the database server 106. In another embodiment, the processor 202 may select the one or more multimedia items from one or more websites, over the communication network 108.

At step 406, a counter variable, “N,” is initialized by “1” for a multimedia item from the selected one or more multimedia items. In an embodiment, the processor 202 may be configured to initialize the counter variable for the multimedia item from the selected one or more multimedia items. In an embodiment, the processor 202 may be configured to process the one or more multimedia items. Thus, at the beginning when a first multimedia item of the one or more multimedia items is processed, the processor 202 may be configured to initialize the counter variable. The value of the counter variable may indicate a positional index of current multimedia item of one or more multimedia items that is processed by the processor 202. For example, if the processor 202 is processing the fourth multimedia item among “35” selected multimedia items, the value of the counter variable, “N,” is “4.”

At step 408, the plurality of features is determined from the multimedia item of the one or more multimedia items. In an embodiment, the processor 202, in conjunction with the speech processor 208, the word processor 210, and the video processor 212, may be configured to determine the plurality of features from the multimedia item of the one or more multimedia items. In an embodiment, the processor 202, in conjunction with the speech processor 208, the word processor 210, and the video processor 212, may utilize one or more of: speech processing techniques, text processing techniques, and video processing techniques, respectively, for determining the plurality of features. In an embodiment, the plurality of features may comprise the set of acoustic features associated with the audio content, the set of lexical features associated with the text content, and the set of visual features associated with the visual content.

In an embodiment, the speech processor 208, in conjunction with the processor 202, may be configured to utilize one or more speech processing techniques known in the art for determining the set of acoustic features from the audio content in the multimedia content. Examples of the one or more speech processing techniques may include, but are not limited to, pitch tracking, harmonic frequency tracking, speech activity detection, and a spectrogram computation. In an embodiment, an acoustic feature in the set of acoustic features may correspond to pitch, intensity, duration of phonemes and/or syllables, speech rate, rhythm and/or the like.

In an exemplary scenario, the multimedia item may correspond to an educational item, such as an audio/video lecture, in which an instructor teaches a specific topic/concept. The voice of the instructor may correspond to the audio content in the multimedia item. In such a scenario, the speech processor 208 may utilize a pitch tracking technique to determine one or more pitch values (i.e., a pitch contour) associated with the voice of the instructor. The speech processor 208 may further utilize a spectrogram computation technique to determine one or more intensity values (i.e., an intensity contour) associated with the voice of the instructor. Using such similar speech processing techniques, the speech processor 208 may further determine a frequency contour, speech rate, rhythm, and duration of the phonemes and syllables associated with the voice of the instructor. The determined pitch contour, intensity contour, frequency contour, speech rate, rhythm, and duration of the phonemes and syllables may collectively correspond to the set of acoustic features.

A person having ordinary skill in the art will understand that the abovementioned exemplary scenario is for illustrative purpose and should not be construed to limit the scope of the disclosure. In an embodiment, the set of acoustic features may further include other audio features such as lexical stress associated with the audio content in the multimedia item.

In an embodiment, the word processor 210, in conjunction with the processor 202, may be configured to utilize one or more text processing techniques known in the art for determining the set of lexical features from the text content in the multimedia content. In an embodiment, when no text content is available in the multimedia item, the speech processor 208 may be configured to convert the audio content into the text content by using ASR techniques. Examples of the one or more text processing techniques may include, but are not limited to, n-gram modelling, parts of speech tagging, and syntax extraction. In an embodiment, a lexical feature in the set of lexical features may correspond to filler keywords, and/or grammatical structure.

In an exemplary scenario, the multimedia item may correspond to an educational item, such as an audio/video lecture, in which an instructor teaches a specific topic/concept. The voice of the instructor may correspond to the audio content in the multimedia item. A text transcript (i.e., the text content) of the voice of the instructor is displayed as sub-titles in the educational item. In such a scenario, the word processor 210 may perform n-gram modelling of the text transcript to determine filler keywords in the text transcript. The word processor 210 may further utilize parts of speech tagging and syntax extraction techniques to determine the grammatical structure associated with the text transcript. The determined filler keywords and grammatical structure may collectively correspond to the set of lexical features.

A person having ordinary skill in the art will understand that the abovementioned exemplary scenario is for illustrative purpose and should not be construed to limit the scope of the disclosure.

In an embodiment, the video processor 212, in conjunction with the processor 202, may be configured to utilize one or more video processing techniques known in the art for determining the set of visual features from the visual content in the multimedia content. Examples of the one or more video processing techniques may include, but are not limited to, gesture recognition and articulator movement tracking. In an embodiment, a visual feature in the set of visual features may correspond to filler gestures, movements of vocal-track articulators and/or the like of a subject, such as an individual, in the multimedia item.

In an exemplary scenario, the multimedia item may correspond to an educational item, such as an audio/video lecture, in which an instructor teaches a specific topic/concept. Further, the educational item may comprise a visual display (i.e., the video content) of the instructor while the instructor teaches the specific topic/concept in the educational item. In such a scenario, the video processor 212 may utilize gesture recognition on the visual display of the instructor to determine the gestures, such as hand movements and facial expressions, of the instructor. The video processor 212 may further utilize articulator movement tracking techniques to determine the movements of vocal-track articulators (such as lips, jaws, tongue, and/or the like) of the instructor. The determined gestures, and movements of vocal-track articulators may collectively correspond to the set of visual features.

A person having ordinary skill in the art will understand that the abovementioned exemplary scenario is for illustrative purpose and should not be construed to limit the scope of the disclosure.

At step 410, the plurality of features is classified into the plurality of speaking style categories. In an embodiment, the processor 202 may be configured to classify the plurality of features into the plurality of speaking style categories. In an embodiment, the processor 202 may classify the plurality of features into the plurality of speaking style categories based on the determined association of each of the plurality of features with each of the plurality of speaking style categories. For example, the processor 202 may classify the gestures determined from the visual content of the multimedia item into the speaking style category “liveliness,” based on the association. In an embodiment, the processor 202 may utilize the trained classifiers (i.e., the first classifier and the plurality of second classifiers) to classify the plurality of features into the plurality of speaking style categories.

A person having ordinary skill in the art will understand that the abovementioned example is for illustrative purpose and the scope of classification is not limited to only classifying the determined gestures into the speaking style category “liveliness.”

At step 412, the engagement score for the multimedia item is determined, based on the classified plurality of features and the weight associated with each of the plurality of speaking style categories. In an embodiment, the processor 202 may be configured to determine the engagement score for the multimedia item based on the classified plurality of features and the weight associated with each of the plurality of speaking style categories. The processor 202 may utilize the trained first classifier to determine the engagement score for the multimedia item.

In an exemplary scenario, the user-request may comprise the one or more user preferences pertaining to the plurality of features, such as “acoustic features and lexical features.” In this scenario, the trained first classifier may determine the engagement score only based on the classified set of acoustic features and the classified set of lexical features among the classified plurality of features.

In an embodiment, the processor 202 may be further configured to customize the first classifier based on the one or more user preferences. In an exemplary scenario, the one or more user preferences may include “high fluency, clarity and formality with moderate liveliness.” In this scenario, the processor 202 may update the weights assigned to each of the plurality of speaking style categories based on the one or more user preferences, such that the speaking style categories such as “fluency,” “clarity” and “formality” are given higher weight in comparison to the speaking style category “liveliness.”

At step 414, the speaking style score is determined, for the multimedia item, for each of the plurality of speaking style categories based on the classified plurality of features. In an embodiment, the processor 202 may be configured to determine the speaking style score, for the multimedia item, for each of the plurality of speaking style categories based on the classified plurality of features. In an embodiment, the processor 202 may utilize the plurality of second classifiers to determine the speaking style score for the multimedia item, for each of the plurality of speaking style categories.

In an embodiment, the processor 202 may utilize the second classifier associated with the corresponding speaking style category to determine the speaking style score of the multimedia item for the corresponding speaking style category. For example, the processor 202 may utilize the second classifier associated with the speaking style category “liveliness” to determine the speaking style score of the multimedia item with respect to the speaking style category “liveliness.”

At step 416, a check is performed to determine whether the current value of the counter variable, “N,” is greater than a total count of the selected one or more multimedia items, “M.” In an embodiment, the processor 202 may be configured to perform the check to determine whether the current value of the counter variable, “N,” is greater than the count of the selected one or more multimedia items, “M.” In an embodiment, if the processor 202 determines that the current value of the counter variable, “N,” is less than the count of the selected one or more multimedia items, “M,”, the control passes back to step 408 to process the next multimedia item among the one or more multimedia items and the counter variable, “N,” is incremented by “1.” Else, control passes to step 418.

At step 418, a check is performed to determine whether the user-request includes the one or more user-preferences. In an embodiment, the processor 202 may be configured to perform the check to determine whether the one or more user-preferences are included in the user-request. In an embodiment, if the processor 202 determines that the user-request includes the one or more user-preferences, the control passes to step 420. Else, control passes to step 422.

At step 420, the one or more multimedia items are ranked based on the speaking style score associated with each of the one or more multimedia items. In an embodiment, the processor 202 may be configured to rank the one or more multimedia items based on the speaking style score associated with each of the one or more multimedia items.

Before ranking, the processor 202 may be configured to identify the speaking style categories specified by the user in the one or more user preferences. The processor 202 may further rank the one or more multimedia items for the speaking style categories specified by the user based on the corresponding speaking style scores of the one or more multimedia items. For example, the one or more user preferences may include “lively” and “clear.” In this scenario, the processor 202 may determine two ranked lists of the one or more multimedia items. One of the two ranked lists is based on the speaking style scores of the one or more multimedia items corresponding to the speaking style category “liveliness” and the second ranked list is based on the speaking style scores of the one or more multimedia items corresponding to the speaking style category “clarity.” Further, a multimedia item with the highest speaking style score may be at the top of a corresponding ranked list.

A person having ordinary skill in the art will understand that the abovementioned example is for illustrative purpose and should not be construed to limit the scope of the disclosure.

At step 422, the one or more multimedia items are ranked based on the engagement score associated with each of the one or more multimedia items. In an embodiment, the processor 202 may be configured to rank the one or more multimedia items based on the engagement score associated with each of the one or more multimedia items. In an embodiment, the one or more multimedia items may be ranked in a descending order, such that the multimedia item with highest engagement score is at the top. In another embodiment, the one or more multimedia items may be ranked in an ascending order, such that the multimedia item with the highest engagement score is at the bottom.

At step 424, the ranked one or more multimedia items are presented to the user through the user-interface displayed on the user-computing device 102. In an embodiment, the processor 202, in conjunction with the transceiver 206, may be configured to present the ranked one or more multimedia items to the user through the user-interface displayed on the user-computing device 102. In an embodiment, when no user preference is present in the user-request, the user-interface may comprise the one or more multimedia items ranked based on the engagement score. For example, the multimedia item with the highest engagement score may be displayed on top followed by multimedia items with lesser engagement scores.

In an alternate embodiment, when the user-request includes the one or more user preferences, the user-interface may further comprise the one or more multimedia items ranked based on the speaking style categories specified in the one or more user preferences. The user-interface may further comprise the one or more multimedia items ranked based on the speaking style categories specified in the one or more user preferences. In an exemplary scenario, the one or more user preferences, such as “lively” and “clear,” are included in the user-request, the user-interface may comprise three ranked lists, two for each of the speaking style categories, such as “liveliness” and “clarity,” associated with the one or more user preferences, such as “lively” and “clear,” and one for the engagement score.

A person having ordinary skill in the art will understand that the abovementioned example is for illustrative purpose and should not be construed to limit the scope of the disclosure. Control passes to end step 426.

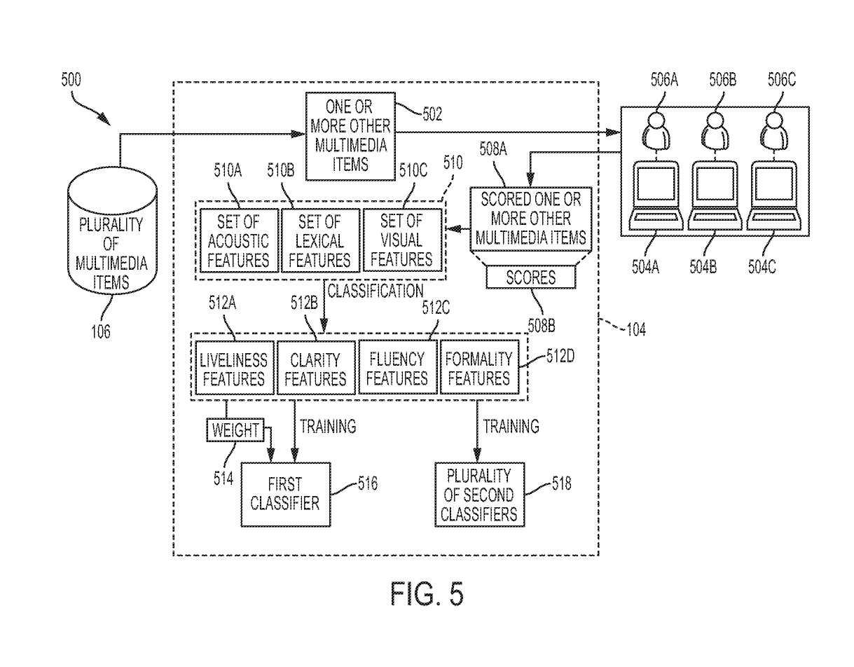

FIG. 5 is a block diagram of an exemplary scenario for training classifiers for automatic ranking of online multimedia items, in accordance with at least one embodiment. FIG. 5 is described in conjunction with FIGS. 1-4A. With reference to FIG. 5, there is shown an exemplary scenario 500 for training the first classifier and the plurality of second classifiers for automatic ranking of the one or more multimedia items.

With reference to the exemplary scenario 500, the application server 104 may retrieve the one or more other multimedia items 502 of the plurality of multimedia items stored in the database server 106. Thereafter, the application server 104 may transmit the one or more other multimedia items 502 to the one or more other computing devices, such as computing devices 504A-504C, associated with the one or more other users, such as users 506A-506C, respectively. The one or more other users, such as users 506A-506C, are presented with the task to assign score, to each of the one or more other multimedia items 502, for each of the plurality of speaking style categories and the engagement attribute.

Thereafter, the application server 104 may receive the scored one or more other multimedia items 508A and the corresponding scores 508B. In an embodiment, the application server 104 may normalize the scores 508B for further processing of the scored one or more other multimedia items 508A. Further, the application server 104 may determine the plurality of features 510 from the scored one or more other multimedia items 508A. The plurality of features 510 includes the set of acoustic features 510A, the set of lexical features 5108, and the set of visual features 510C. The application server 104 may utilize one or more of: speech processing techniques, text processing techniques, and video processing techniques for determining the plurality of features 510.

Thereafter, the application server 104 may determine the association of the plurality of features 510 with the plurality of speaking style categories based on the scores 508B for each of the plurality of speaking style categories. The application server 104 may further classify the plurality of features 510 into the plurality of speaking style categories, such as “liveliness,” “clarity,” “fluency,” and “formality,” based on the association. The classified plurality of features 512 may include liveliness features 512A, clarity features 5128, fluency features 512C, and formality features 512D.

The application server 104 may further determine a weight 514 for each of the plurality of speaking style categories based on a correlation of the normalized score of each of the plurality of speaking style categories and the normalized score of the engagement attribute. Thereafter, the application server 104 may train the first classifier 516 based on the weight 514 of each of the plurality of speaking style categories and the classified plurality of features 512. The application server 104 may further train the each of the plurality of second classifiers 518 based on the classified plurality of features 512 in the corresponding plurality of speaking style category.

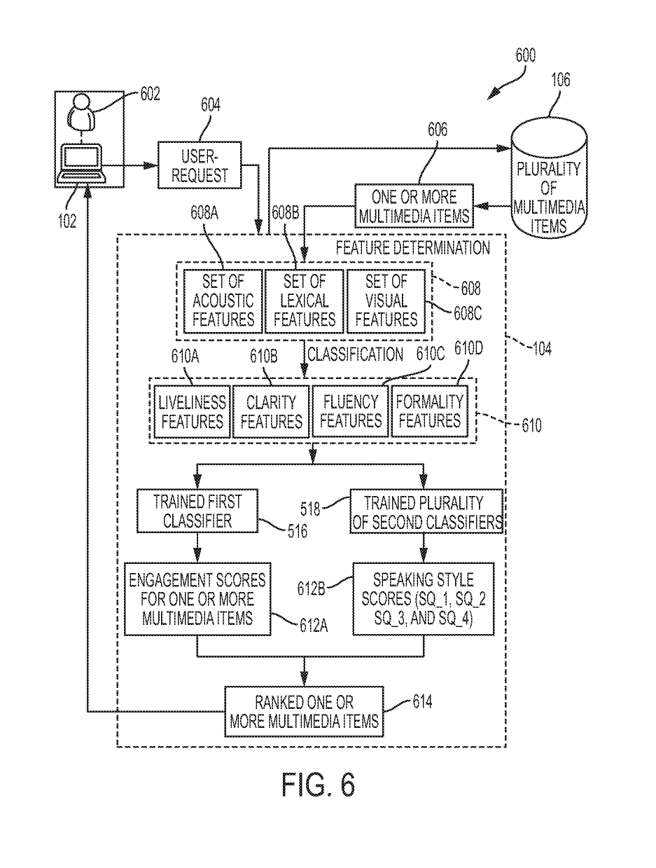

FIG. 6 is a block diagram of an exemplary scenario for automatic ranking of online multimedia items by using trained classifiers, in accordance with at least one embodiment. FIG. 6 is described in conjunction with FIGS. 1-5. With reference to FIG. 6, there is shown an exemplary scenario 600 for automatic ranking of the one or more multimedia items.

With reference to the exemplary scenario 600, the user 602 associated with the user-computing device 102 transmits the user-request 604 to the application server 104. The user-request 604 comprises a search query, such as “lecture videos on Einstein's theory of relativity,” and one or more user preferences, such as “clear and fluent,” pertaining to the plurality of speaking style categories. Based on the user-request 604, the application server 104 may query the database server 106 to select the one or more multimedia items 606 from the plurality of multimedia items. The one or more multimedia items 606 are associated with a specific topic, such as “theory of relativity,” specified by the user 602 in the search query of the user-request 604.

The application server 104 may receive the selected one or more multimedia items 606 from the database server 106. Thereafter, the application server 104 may determine the plurality of features 608 from each of the one or more multimedia items 606. The plurality of features 608 may include a set of acoustic features 608A, a set of lexical features 608B, and a set of visual features 608C. The plurality of features 608 are further classified into the plurality of speaking style categories by the application server 104, based on the association of each of the plurality of features 608 with each of the plurality of speaking style categories. The classified plurality of features 610 includes liveliness features 610A, clarity features 610B, fluency features 610C, and formality features 610D.

The application server 104 may utilize the trained classifiers, such as the trained first classifier 516, to determine the engagement scores 612A for each of the one or more multimedia items 606 based on the classified plurality of features 610. The application server 104 may further utilize the trained classifiers, such as the trained plurality of second classifiers 518, to determine the speaking style scores 612B for each of the one or more multimedia items 606 based on the classified plurality of features 610. For example, a trained classifier among the plurality of second classifiers 518 determines a speaking style score, such as “SQ_1,” “SQ_2,” “SQ_3,” or “SQ_4,” for a corresponding speaking style category, such as “liveliness,” “clarity,” “fluency,” or “formality,” respectively.

Based on the engagement scores 612A and the speaking style scores 612B, the application server 104 may rank the one or more multimedia items 606. Further, the ranked one or more multimedia items 614 are presented to the user 602 through a user-interface displayed on a display screen of the user-computing device 102. Thereafter, the user 602 may select a multimedia item from the ranked one or more multimedia items 614. The application server 104 may be further configured to render the multimedia item selected by the user 602 on the display screen of the user-computing device 102.

A person having ordinary skill in the art will understand that the abovementioned exemplary scenarios are for illustrative purpose and should not be construed to limit the scope of the disclosure.

The disclosed embodiments encompass numerous advantages. The disclosure provides a method and a system for automatic ranking of online multimedia items. The disclosed methods and systems utilize a multimodal approach for ranking the multimedia items based on a plurality of speaking style categories. The multimodal approach includes determining a plurality of features associated with audio content, text content, and visual content of the multimedia items. The multimedia items are ranked based on an engagement score that is determined based on the plurality of features. The disclosed methods and systems further allow the user to specify one or more user preferences pertaining to speaking style categories and the plurality of features. Thus, the multimedia items are further ranked based on the specified speaking style categories. The disclosed methods and systems display an automatically ranked list of topic specific multimedia items based on a search query by utilizing trained classifiers, without any human intervention. The disclosed methods and systems may be utilized by one or more multimedia content providers, such as an education provider, to enhance metadata associated with a multimedia item by including the engagement score determined for the multimedia item.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for multimedia content processing for automatic ranking of online multimedia items have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of multimedia content processing for automatic ranking of online multimedia items, the method comprising:
selecting, by one or more processors in a computing device, one or more multimedia items based on a user-request received from a user-computing device;
for a multimedia item from the one or more selected multimedia items:
determining, by the one or more processors in the computing device, a plurality of features from the multimedia item based on audio content, text content and visual content associated with the multimedia item;
classifying, by the one or more processors in the computing device, the plurality of features into a plurality of speaking style categories based on an association of the plurality of features with the plurality of speaking style categories;
determining, by the one or more processors in the computing device, an engagement score for the multimedia item based on the classified plurality of features and a weight associated with each of the plurality of speaking style categories by utilizing a first classifier, wherein the first classifier is trained based on the plurality of features determined from one or more other multimedia items; and
ranking, by the one or more processors in the computing device, the one or more multimedia items based on at least the determined engagement score associated with each of the one or more multimedia items, wherein the ranked one or more multimedia items are presented to a user through a user-interface displayed on the user-computing device.

2. The method of claim 1, wherein the plurality of features comprises a set of acoustic features associated with the audio content, a set of lexical features associated with the text content, and a set of visual features associated with the visual content.

3. The method of claim 1, further comprising transmitting, by one or more transceivers in the computing device, the one or more other multimedia items to one or more other computing devices associated with one or more other users, wherein the one or more other users are presented a task to assign a score, to each of the one or more other multimedia items, for each of the plurality of speaking style categories and an engagement attribute associated with each of the one or more other multimedia items.

4. The method of claim 3, further comprising determining, by the one or more processors in the computing device, the plurality of features from the one or more other multimedia items received from the one or more other computing devices.

5. The method of claim 3, wherein the association of the plurality of features with the plurality of speaking style categories is determined based on the score assigned by the one or more other users to each of the one or more other multimedia items for each of the plurality of speaking style categories.

6. The method of claim 3, wherein the weight associated with each of the plurality of speaking style categories is determined based on the score assigned by the one or more other users to each of the one or more other multimedia items for each of the plurality of speaking style categories and the engagement attribute.

7. The method of claim 1, further comprising determining, by the one or more processors in the computing device, a speaking style score, for each of the one or more multimedia items, for each of the plurality of speaking style categories based on the classified plurality of features by utilizing a plurality of second classifiers.

8. The method of claim 7, wherein the plurality of second classifiers is trained based on the plurality of features determined from the one or more other multimedia items.

9. The method of claim 7, wherein the one or more multimedia items are further ranked for each of the plurality of speaking style categories based on the user-request and the speaking style score associated with each of the one or more multimedia items for each of the corresponding plurality of speaking style categories.

10. The method of claim 1, wherein the plurality of features is determined from each of the one or more multimedia items by utilizing one or more of: speech processing techniques, text processing techniques, and video processing techniques.

11. The method of claim 1, wherein a category in the plurality of speaking style categories is associated with liveliness, fluency, clarity, or formality.

12. A system of multimedia content processing for automatic ranking of online multimedia items, the system comprising:
one or more processors in a computing device configured to:
select one or more multimedia items based on a user-request received from a user-computing device;
for a multimedia item from the one or more selected multimedia items:
determine a plurality of features from the multimedia item based on audio content, text content and visual content associated with the multimedia item;
classify the plurality of features into a plurality of speaking style categories based on an association of the plurality of features with the plurality of speaking style categories;
determine an engagement score for the multimedia item based on the classified plurality of features and a weight associated with each of the plurality of speaking style categories by utilizing a first classifier, wherein the first classifier is trained based on the plurality of features determined from one or more other multimedia items;
rank the one or more multimedia items based on at least the determined engagement score associated with each of the one or more multimedia items, wherein the ranked one or more multimedia items are presented to a user through a user-interface displayed on the user-computing device.

13. The system of claim 12, wherein the one or more processors in the computing device are further configured to transmit the one or more other multimedia items to one or more other computing devices associated with one or more other users, wherein the one or more other users are presented a task to assign a score, to each of the one or more other multimedia items, for each of the plurality of speaking style categories and an engagement attribute associated with each of the one or more other multimedia items.

14. The system of claim 13, wherein the one or more processors in the computing device are further configured to determine the plurality of features from the one or more other multimedia items received from the one or more other computing devices.

15. The system of claim 13, wherein the association of the plurality of features with the plurality of speaking style categories is determined based on the score assigned by the one or more other users to each of the one or more other multimedia items for each of the plurality of speaking style categories.

16. The system of claim 13, wherein the weight associated with each of the plurality of speaking style categories is determined based on the score assigned by the one or more other users to each of the one or more other multimedia items for each of the plurality of speaking style categories and the engagement attribute.

17. The system of claim 12, wherein the one or more processors in the computing device are further configured to determine a speaking style score, for each of the one or more multimedia items, for each of the plurality of speaking style categories based on the classified plurality of features by utilizing a plurality of second classifiers.

18. The system of claim 17, wherein the plurality of second classifiers is trained based on the plurality of features determined from the one or more other multimedia items.

19. The system of claim 17, wherein the one or more multimedia items are further ranked for each of the plurality of speaking style categories based on the user-request and the speaking style score associated with each of the one or more multimedia items for each of the corresponding plurality of speaking style categories.

20. A computer program product for use with a computer, the computer program product comprising a non-transitory computer readable medium, wherein the non-transitory computer readable medium stores a computer program code for automatic ranking of online multimedia items, wherein the computer program code is executable by one or more processors to:
select one or more multimedia items based on a user-request received from a user-computing device;
for a multimedia item from the one or more selected multimedia items:
determine a plurality of features from the multimedia item based on audio content, text content and visual content associated with the multimedia item;
classify the plurality of features into a plurality of speaking style categories based on an association of the plurality of features with the plurality of speaking style categories;
determine an engagement score for the multimedia item based on the classified plurality of features and a weight associated with each of the plurality of speaking style categories by utilizing a first classifier, wherein the first classifier is trained based on the plurality of features determined from one or more other multimedia items;
rank the one or more multimedia items based on at least the determined engagement score associated with each of the one or more multimedia items, wherein the ranked one or more multimedia items are presented to a user through a user-interface displayed on the user-computing device.
